(19) United States
(12) Patent Application Publication
(10) Pub. No.: US 2014/0214899 A1
(43) Pub. Date: Jul. 31, 2014

(54) LEAF NAMES AND RELATIVE LEVEL INDICATIONS FOR FILE SYSTEM OBJECTS

(71) Applicant: HEWLETT-PACKARD DEVELOPMENT COMPANY, L.P., Houston, TX (US)

(72) Inventor: Pradeep Ganapathy, Bangalore (IN)

(73) Assignee: HEWLETT-PACKARD DEVELOPMENT COMPANY, L.P., Houston, TX (US)

(21) Appl. No.: 13/749,955

(22) Filed: Jan. 25, 2013

(51) Int. Cl. G06F 17/30

(52) U.S. Cl. CPC G06F 17/30091
USPC 707/797

(57) ABSTRACT

In some implementations, a first data structure includes leaf names identifying file system objects, the first data structure not including information relating to file system paths of the respective file system objects. Indications of relative levels of the file system data objects are provided, where a given one of the indications specifies a level of the corresponding file system object relative to a previous file system object identified in the first data structure.

### BACKGROUND

To protect the integrity of data in the event of a fault or other condition that may cause data loss, data stored in a system may be backed up to a separate backup storage location. The data that is backed up can include files and directories of a file system. Files and directories of the file system can be identified to be backed up, and data associated with such identified files and directories can then be copied to the backup storage location.

### BRIEF DESCRIPTION OF THE DRAWINGS

Some embodiments are described with respect to the following figures:

FIG. 1 is a schematic diagram of a name of a file system object, according to some implementations;

FIG. 2A is a schematic diagram of an example operation of a backup application, according to some implementations;

FIG. 2B is a flow diagram of a process performed by a reader module of the backup application according to some implementations;

FIG. 2C is a flow diagram of a process performed by a writer module of the backup application according to some implementations;

FIG. 3 is a schematic diagram of a hierarchical view of file system objects that are associated with user-selectable boxes according to some implementations for selecting file system objects to back up;

FIG. 4 is a schematic diagram of an example backup list that includes leaf names of file system objects, according to some implementations;

FIG. 5 is a block diagram of an example arrangement that includes a backup system according to some implementations; and

FIG. 6 is a flow diagram of a traversal procedure that can be invoked by a backup application according to some implementations.

### DETAILED DESCRIPTION

A file system can refer to a system (made up of one or multiple components) for managing the access of data organized into files and directories. In some cases, the files and directories themselves can be considered to be part of the file system. More generally, the files and directories of a file system can be referred to as file system objects, where a file system object can be a file or a directory of the file system. The component(s) for managing the access of file system objects can include machine-readable instructions (which can include software and/or firmware). A file system can also include data structures used for organizing the file system objects in the file system. The file system can include a hierarchical tree structure in which the file system objects can be arranged at different hierarchical levels, such as directories and files at various different levels.

In a production environment (which is an environment in which a file system is actively being used by users and applications), the number of file system objects can grow relatively rapidly, especially if there are a relatively large number of users and applications. In a large file system that has may users and applications, the file system can grow on the order of thousands of file system objects per minute, for example.

As the number of file system objects grow, a namespace of the file system also grows. A namespace can refer to an environment or an abstract container that is used to hold a logical grouping of identifiers or symbols (i.e. names) of file system objects in the file system.

In performing backup of data in a file system (by a backup application) to protect the integrity of such data in the event of a fault or other condition that may cause data loss, the data of the file system can be backed up to a backup storage location. In performing data backup of file system objects, metadata of a file system namespace can be provided, where the provided namespace metadata corresponds to the file system objects that are to be backed up. Namespace metadata can include names of file system objects, as well as other metadata (discussed further below). The namespace metadata can be used to write the data of the corresponding file system objects to the backup storage location. If the file system namespace is growing at a relatively rapid rate, a backup application may continually find new entries in the file system namespace to backup. As a result, the backup operation may enter into a loop condition where namespace metadata is being added for file system objects to be backed up before the corresponding data writes to the backup storage location can complete. The loop condition may cause the backup operation to run indefinitely.

Additionally, with a relatively large file system, the amount of namespace metadata that is recorded for file system objects that are to be backed up can be relatively large. For improved backup performance, it may be desirable to store the namespace metadata in relatively high-speed memory, rather than in a relatively slow persistent storage subsystem (which can be implemented with one or multiple disk-based storage devices or solid state storage devices). However, a relatively large file system namespace may cause an excessive amount of storage space consumption in the memory, which may not be easily predicted ahead of time. Since the memory of a system is a shared resource (shared by multiple different applications), it may be undesirable to allow the backup application to have unbounded usage of the memory.

In accordance with some implementations, techniques or mechanisms are provided to allow for bounded usage of memory by a backup application for storing namespace metadata of file system objects that are to be backed up. In this way, the amount of the memory used to store namespace metadata for a backup operation does not extend beyond an upper bound, which specifies a maximum amount of storage space of the memory that can be used for the backup operation. In this way, a fixed memory footprint can be defined for the backup application.

In some implementations, the namespace metadata of a file system object can include the following: name of the file system object, type of the file system object, size of the file system object, and so forth. The name of a file system object can be used to identify a unique location of the corresponding file system object in the file system. The name can include a leaf name that is an identifier of the file system object, as well as a path to a location in the file system that stores the file system object.

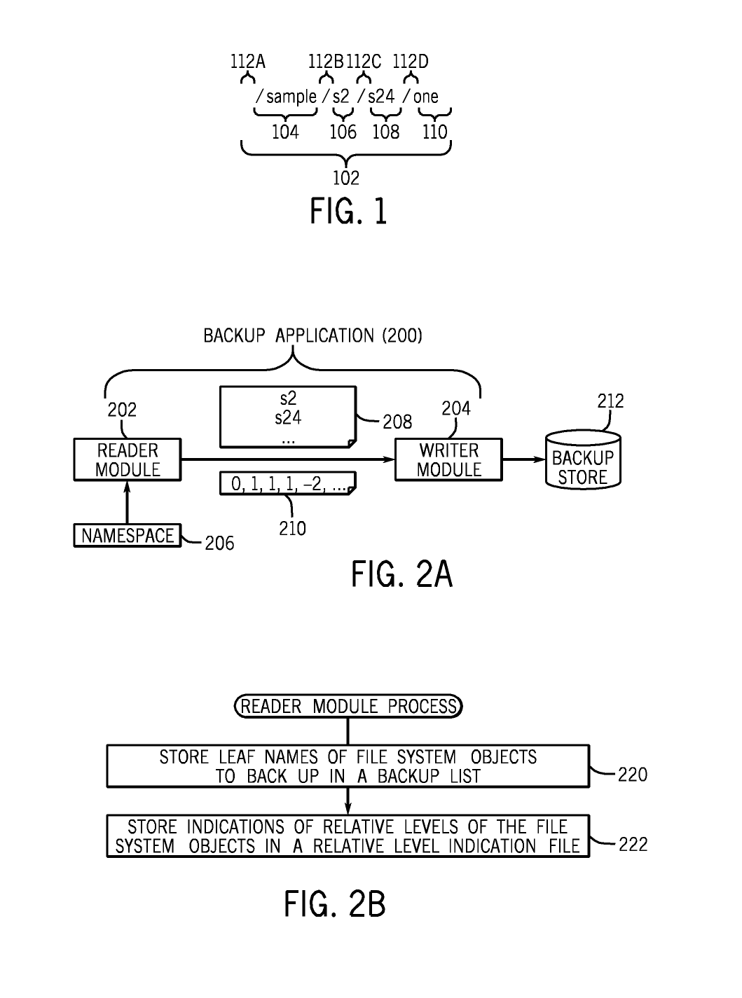

FIG. 1 shows an example name 102 of a file system object (e.g. a file named “one”). The name 102 includes a leaf name 110, which in the example is “one.” The name 102 also includes a path composed of strings of characters that are separated by delimiting characters 112 (112A-112D shown in FIG. 1). An example delimiting character can be in the form of a slash “/”; in other examples, other delimiting characters can be used in a path.

In the example of FIG. 1, the path includes a first character string 104 (“sample”) following a first delimiting character 112A, a second character string 106 (“s2”) following a second delimiting character 112B, a third character string 108 (“s24”) following a third delimiting character 112C, and a fourth delimiting character 112D between the third character string 108 and the leaf name 110. The character strings 104, 106, and 108 identify three different directories (“sample” directory, “s2” directory, and “s24” directory, respectively) at different hierarchical levels of a file system tree hierarchy.

Generally, a path points to a location in the file system by including character strings that identify respective directories of a file system tree hierarchy that are part of the path.

A backup application can record, into a backup data structure (e.g. a backup list), the namespace metadata of file system objects that are to be backed up. If the entire name (including the path) of each of the file system objects to be backed up is recorded in the backup data structure (which is stored in memory), then that can cause the size of the backup data structure to be relatively large, which increases usage of memory.

In accordance with some implementations, instead of recording the entire name including the path of each file system object to be backed up, the leaf name of each file system object to be backed up can be recorded into the backup data structure. In other words, the path of a name is not recorded into the backup data structure, which reduces the amount of namespace metadata that is included in the backup data structure. In this way, the size of the backup data structure can be smaller than the size of a backup data structure that stores the entire name of each file system object that is to be backed up. By reducing the size of the backup data structure, the amount of memory consumption is reduced, which allows for the specification of a fixed memory footprint for the backup application.

Although reference is made to techniques or mechanisms in the context of data backup performed by a backup application, it is noted that the techniques or mechanisms according to some implementations can also be applied in other contexts that involve storing of namespace metadata for file system objects, in which bounded usage of memory is desired.

FIG. 2A is a schematic diagram illustrating operation of a backup application 200 according to some implementations. The backup application 200 includes a reader module 202 and a writer module 204. The reader module 202 traverses a namespace 206 of a file system, where the namespace 206 includes entries corresponding to respective file system objects. Each namespace entry includes the metadata for the respective file system object. The namespace 206 can be in the form of a hierarchical tree structure having entries that represent the relationships of file system objects, including directories and files.

The reader module 202 can traverse the entries of the namespace 206 to retrieve corresponding namespace metadata. The traversal of the namespace entries (arranged in a hierarchical tree structure) can be performed in a breadth-first or depth-first manner. Breadth-first traversal of the namespace involves accessing a node of the tree structure, and then visiting a neighbor node of the currently accessed node. Once the neighbor nodes of a current level of the tree structure have been accessed, the process proceeds to the next lower level of the tree structure.

In contrast, a depth-first traversal of the namespace involves starting at a root node and proceeding down various levels of a branch of the tree structure from the root node until a leaf node is reached. The depth-first traversal then backtracks to the beginning of the branch to proceed down the next branch.

In other examples, other manners of traversing the namespace 206 can be employed by the reader module 202.

The reader module 202 provides, to the writer module 204, information pertaining to file system objects to back up. As discussed above, such information provided can include a backup list 208, which is a list of namespace metadata corresponding to file system objects that are to be backed up. In some examples, the namespace metadata includes just leaf names of respective file system objects (and does not include the paths of the respective file system objects). Note that the backup list 208 can include other namespace metadata in addition to the leaf names, where the other namespace metadata can include file system object type information and file system object size information, as examples.

By not including the paths of file system objects in the backup list 208, the size of the backup list 208 can be reduced, as compared to the size of a backup list that stores the full name (including the path) of each file system object to be backed up.

Since the backup list 208 includes leaf names of file system objects without respective paths, the information provided by the reader module 202 to the writer module 204 further includes a relative level indication file 210 that includes additional information to allow the writer module 204 to determine the location of each file system object identified by a respective leaf name in the backup list 208. Since a file system location is usually specified by a path, the lack of path information in the backup list 208 would prevent the writer module 204 from ascertaining the location of the respective file system object identified by a leaf name in the backup list 208. To address the foregoing issue, the relative level indication file 210 includes information that allows the writer module 204 to determine relative levels between file system objects identified by leaf names in the backup file 208. In some examples, the relative level indication file 210 includes a sequence of numbers, where each number specifies the relative level of a given file system object to a previous file system object in the backup list 208.

For example, a +1 value in the relative level indication file 210 indicates that the respective file system object is one level below the file system object identified by the previous leaf name in the backup list 208. On the other hand, a −1 value in the relative level indication file 210 indicates that the respective file system object is one level above the file system object identified by the previous leaf name in the backup list 208.

In the example of FIG. 2A, two leaf names s2 and s24 are included in the backup list 208. These two leaf names are associated with the first two numbers of the relative level indication file 210. In other words, the leaf name s2 is associated with the number 0, whereas the leaf name s24 is associated with the number +1. Since the leaf name s2 is the first entry of the backup list 208, the leaf name s2 is associated with the number 0. On the other hand, the second leaf name s24 is associated with the number +1, which indicates that the file system object identified by the leaf name s24 is one level (in the directory tree structure) below the file system object identified by the leaf name s2.

More generally, a positive number in the relative level indication file 210 indicates that the file system object identified by the respective leaf name in the backup list 208 is below the file system object identified by the previous leaf name in the backup list 208. On the other hand, a negative number in the relative level indication file 210 indicates that the file system object identified by the respective leaf name in the backup list 208 is above the file system object identified by the previous leaf name in the backup list 208. A number having a zero value indicates that a file system object identified by the respective leaf name is at the same level as a file object identified by the previous leaf name in the backup list 208.

In other implementations, instead of using a sequence of numbers in the relative level indication file 210, other symbols or characters can be used instead for representing relative level between different file system objects.

In response to the information (including the backup list 208 and the relative level indication file 210) from the reader module 202, the writer module 204 is able to retrieve the identified file system objects, and to write the data of such file system objects to a backup store 212 for data backup. The writer module 204 uses the combination of the leaf names in the backup list 208 and the relative levels between file system objects identified by the relative level indication file 210 to identify the locations of the file system objects, such that the writer module 204 can retrieve the data from the respective file system objects. Effectively, the writer module 204 is able to use the content of the backup list 208 and the relative level indications from the file 210 to reconstruct the namespace hierarchy, without having to load the namespace 206 into memory.

The backup store 212 can be implemented with external storage media, which is external of a system that includes the backup application 200 and the file system objects accessible by the backup application 200.

In addition, it is desirable to avoid the situation where the reader module 202 is continually sending further namespace metadata to the writer module 204 regarding file system objects to back up before the writer module 204 can complete the data writing process to the backup store 212, which can result in a continual loop that may run indefinitely. Note that the data writes to the backup store 212 can be slower than the process of reading the namespace 206 by the reader module 202.

To avoid the condition of a backup operation that runs indefinitely, the information including the backup list 208 and the associated relative level indication file 210 is generated at a specific point in time by the reader module 202. The information generated by the reader module 202 at the specific point in time causes information of file system objects that existed at or prior to that specific point of time to be backed up. Any new file system objects that are created following the specific point in time would not be backed up. In this way, even if the file system namespace is growing continually at a relatively rapid rate, the namespace metadata of a finite list of file system objects is provided to the writer module 204 for backup.

In contexts other than backup contexts as described above, techniques or mechanisms can produce a data structure (similar to the backup list 208 of FIG. 2A) that includes leaf names without including paths of the respective file system objects. A relative level indication file can also be created for this data structure, to allow for the determination of file system locations based on just leaf names in the data structure. The data structure can be used to perform an operation with respect to the file system objects identified by the leaf names in the data structure, where the operation performed can vary depending upon the associated application.

FIG. 2B is a flow diagram of a process performed by the reader module 202 of the backup application 200, according to some implementations. Based on traversal of the namespace 206, the reader module 202 stores (at 220) leaf names of file system objects to back up in the backup list 208, without storing, in the backup list 208, information relating to file system paths of the respective file system objects.

The reader module 202 further stores (at 222) indications of relative levels of the file system objects in the relative level indication file 210. The relative level indications are based on the information retrieved by traversing the namespace 206.

FIG. 2C is a flow diagram of a process performed by the writer module 204 of the backup application 200, according to some implementations. The writer module 204 receives (at 230) the backup list 208 and the relative level indication file 210. Based on the leaf names from the backup list 208 and the relative level indications from the file 210, the writer module 204 reconstructs (at 232) the file system locations of the file system objects identified by the leaf names. The reconstructed file system locations can be used by the writer module 204 to retrieve data of the file system objects to write to the backup store 212.

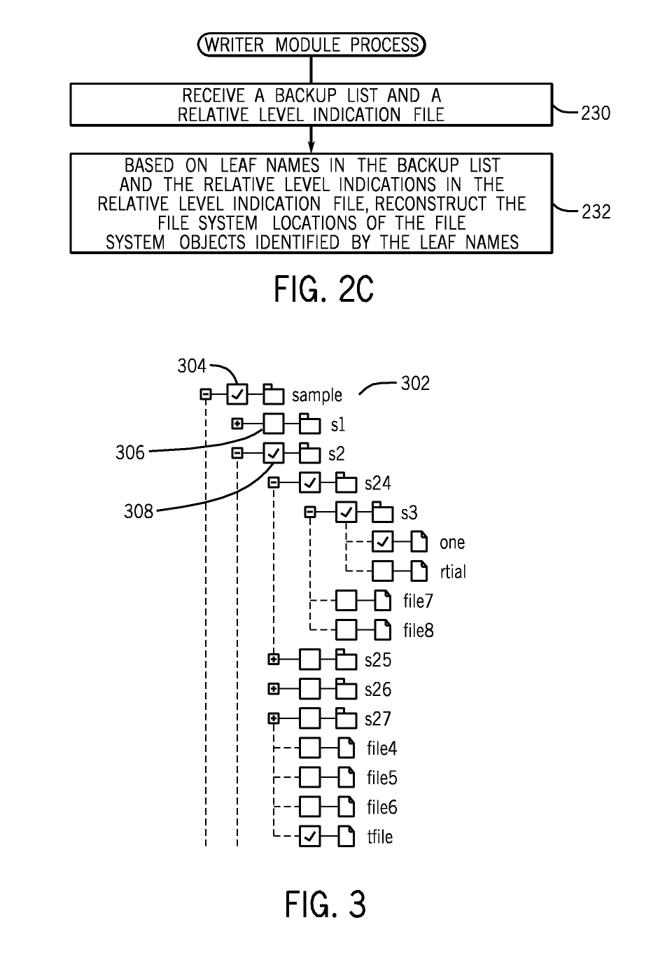

FIG. 3 illustrates an example file system namespace that includes a hierarchy of directories and files that may be selectively backed up by the backup application 200 of FIG. 2A. The namespace of FIG. 3 includes a “sample” directory 302 at the highest level, which may be under the root directory represented by “/.” Under the “sample” directory 302 are an “s1” directory and an “s2” directory. In other words, the “s1” and “s2” directories are included in the “sample” directory. Under the “s2” directory are the following directories: s24, s25, s26, and s27. In addition, the following files are included in the “s2” directory: file4, file5, file6, tfile.

In addition, an “s3” directory is included in the “s24” directory, as are the following files: file7, file8. Moreover, the following files are included in the “s3” directory: one, rtial.

Each file system object represented in the namespace of FIG. 3 is associated with a user-selectable box. For example, the “sample” directory 302 is associated with a selectable box 304, which if selected indicates that the “sample” directory 302 is to be backed up. As another example, a selectable box 306 is associated with the “s1” directory, which is unchecked in the FIG. 3 example. The selectable box 306 being unchecked means that the “s1” directory will not be backed up. On the other hand, a selectable box 308 associated with the “s2” directory is checked, which indicates that the “s2” directory is to be backed up. The other file system objects in the FIG. 3 example that are associated with checked selectable boxes include s24, s3, one, tfile.

The content depicted in FIG. 3 can be presented in a user interface, such as a graphical user interface (GUI). A user can select any of the selectable boxes associated with the file system objects represented in the FIG. 3 view. Based on the selections made to the selectable boxes in the FIG. 3 example, the following are the names (including respective paths) of respective file system objects that are to be backed up:

/sample/s2,
/sample/s2/s24,
/sample/s2/s24/s3,
/sample/s2/s24/s3/one,
/sample/s2/tfile.

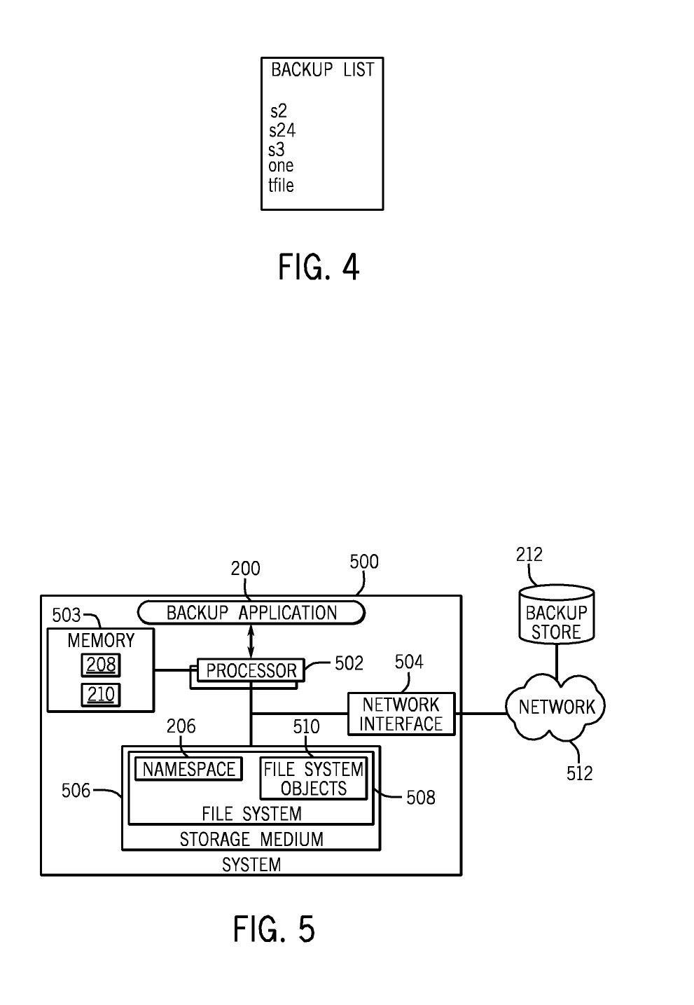

Instead of including the full name of each file system object as listed above in the backup list 208, the backup list 208 is recorded with just the leaf names of the corresponding file system objects. An example of such backup list 208 is shown in FIG. 4. The backup list 208 of FIG. 4 includes the following leaf names: s2, s24, s3, one, tfile. Note that the backup list 208 of FIG. 4 does not include the respective paths of the corresponding file system objects.

The five leaf names in the backup list 208 of FIG. 4 are associated with the relative level indication file 210, which includes five corresponding numbers. For example, the relative level indication file 210 for the backup list 208 can include the following sequence of five numbers associated with the five leaf names (s2, s24, s3, one, tfile), respectively: 0, 1, 1, 1, −2.

Note that although commas are provided between the numbers in the relative level indication file 210, other delimiting characters can be used in other examples, such as a space or other character. Alternatively, no delimiting character is provided between numbers.

The leaf name “s2” is associated with the first file system object (the “s2” directory) to be backed up, such that it is associated with the number 0 in the relative level indication file 210. The second entry of the backup list 208 includes the leaf name “s24,” which is associated with the number +1 in the relative level indication file 210. This means that the “s24” directory is one level in the directory tree below the “s2” directory identified in the previous entry of the backup list 208. Similarly, the “s3” directory is one level below the “s24” directory, and the “one” file is one level below the “s3” directory. However, the “tfile” file is located in the “s24” directory, which is two levels above the “one” file. As a result, a negative number of −2 is provided in the relative level indication file 210 for the “tfile” file, which specifies that the “tfile” file is two levels above the “one” file. This allows the writer module 204 to traverse the tree structure representing the file system back to the s24 directory, to locate the tfile file in the s24 directory.

From the backup list 208 and the relative level indication file 210, the writer module 204 is able to reconstruct each file system object's name to allow the writer module 204 to retrieve the corresponding file system object from the file system location. Once the backup operation is completed, the backup list 208 and relative level indication file 210 can be deleted by the backup application 200. Since these two files are accessed frequently, these files (or sections of these files) can be stored in memory, such that memory mapped sections of the files can be used by the reader and writer modules 202 and 204, to reduce latency associated with I/O access of a relatively slow persistent storage.

Once the backup list 208 and relative level indication file 210 are generated, the writer module 204 of FIG. 2 can perform the following example process, assuming the example described in connection with FIGS. 3 and 4.

The first file system object identified in the backup list 208 is the “s2” directory. The directory in which the “s2” directory is located can be identified in a CWD variable, for example. The value of the CWD variable for the “s2” directory can be /sample/.

In the example discussed above, the leaf name “s2” in the backup list 208 is associated with the number 0 in the relative level indication file 210. This indicates that the “s2” directory remains in the directory (/sample/) identified in the CWD variable.

The leaf name “s24” in the backup list 208 is associated with the number +1 in the relative level indication file 210. This indicates that the “s24” directory is one level below the “s2” directory in the directory tree. As a result, the +1 number causes the CWD variable to be updated to point to a directory that is one level below the previous directory. In the example given, the CWD variable is updated to /sample/s2/s24.

After the writer module 204 has processed the leaf name “one” in the backup list 208, the CWD variable has been updated to /sample/s2/s24/s3, since the “one” file is located in the “s3” directory. To process the next leaf name “tfile” in the backup list 208, the writer module 204 determines that the leaf name “tfile” is associated with a number of −2 in the relative level indication file 210. As a result, the CWD variable is updated to go up two levels, such that the CWD variable is updated to /sample/s2 (note that the “tfile” file is in the “s2” directory).

By using techniques or mechanisms according to some implementations, a fixed amount of memory can be allocated to store information for a backup application 200, which allows for more efficient use of memory. Also, by specifying a point in time associated with performing a backup operation, the backup application 200 can more easily predict an amount of time that is involved in performing the backup operation, which may not be possible if new file system objects were allowed to be continually added to the backup list 208. Moreover, by defining the point in time associated with the backup operation, the backup operation can complete in a finite amount of time, even if the file system namespace is growing at a relatively rapid rate.

Since the backup operation can complete in a finite amount of time, a user can delete file system objects that have been backed up to free up storage space if such storage space has to be used for other data.

FIG. 5 is a block diagram of an example system 500 that includes the backup application 200. The backup application 200 can be implemented as machine-readable instructions that are executable on one or multiple processors 502. A processor can include a microprocessor, microcontroller, processor module or subsystem, programmable integrated circuit, programmable gate array, or another control or computing device. The processor(s) 502 can be connected to a memory 503, a network interface 504, and a storage medium 506. The storage medium 506 can be a persistent storage medium, such as a disk-based storage medium or solid state storage medium. The memory 503 can be implemented with a storage device that has a faster access speed than the storage medium 506. As depicted in FIG. 5, the memory 503 can be used to store the backup list 208 and the relative level indication file 210 associated with the backup application 200.

The network interface 504 allows the system 500 to communicate over a network 512 to allow backup data to be transferred to the backup store 212.

The storage medium 506 can be used to store elements associated with a file system 508. The file system 508 can include machine-readable instructions (not shown) that are for managing the file system 508. The file system 508 can also include the namespace 206, as well as file system objects 510, which can include directories and files.

The memory 503 and storage medium 506 can include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

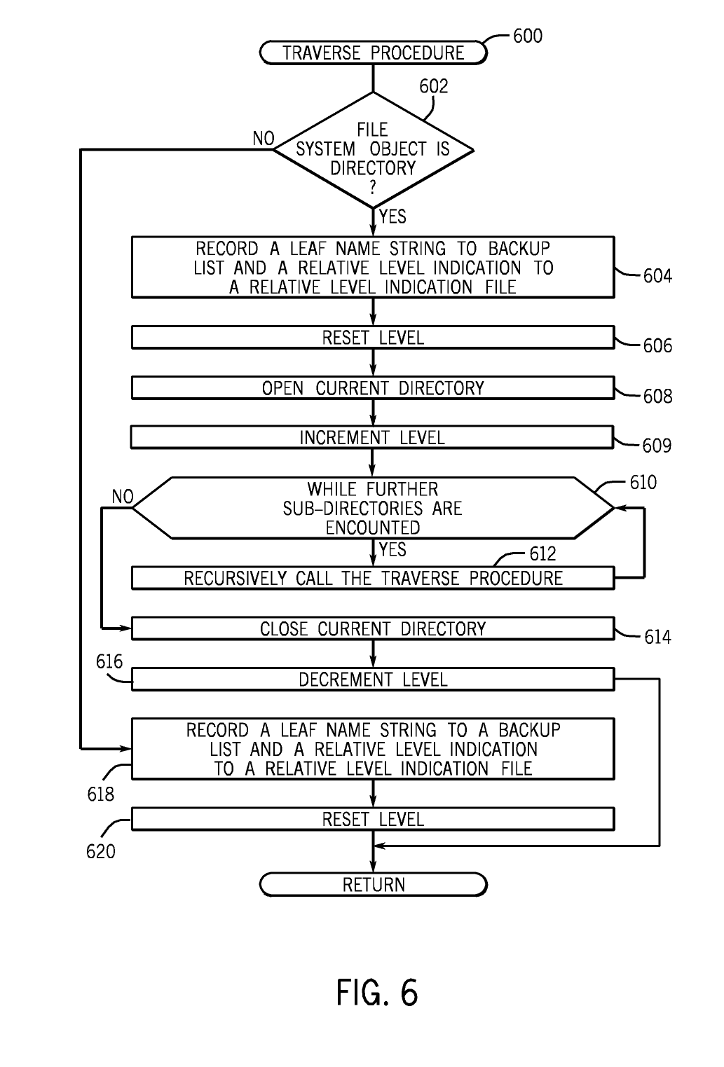

FIG. 6 is a flow diagram of a traverse procedure 600 that can be invoked by the reader module 202 in the backup application 200 of FIG. 2. The traverse procedure 600 can be used to traverse the namespace 206 and to populate the backup list 208 and the relative level indication file 210, according to some implementations. The traverse procedure 600 can be part of the reader module 202, or can be separate from the backup application 200.

The traverse procedure 600 starts with the first file system object (that is to be backed up) in the namespace 206. The traverse procedure 600 determines (at 602) whether the file system object is a directory. If so, the traverse procedure 600 records (at 604) a respective leaf name string to the backup list 208 and a relative level indication (expressed in a LEVEL variable) to the relative level indication file 210. For the first file system object, the LEVEL variable contains a zero value, which is written to the relative level indication file 210.

After recording (at 604) the respective leaf name string and the relative level indication (LEVEL), the traverse procedure 600 resets (at 606) the value of the variable LEVEL to zero, to allow re-computation of the LEVEL value for the next file system object traversed in the namespace 206.

The current directory is opened (at 608), and the value of LEVEL is incremented (at 609) by one. If the current directory includes additional sub-directories, as determined (at 610), then the traverse procedure 600 is recursively called (at 612) for each such sub-directory. The recursive calling of the traverse procedure 600 for each sub-directory results in repeating the tasks 602, 604, 606, 608, 609, and 610 (which causes the backup list 608 and the relative level indication file 610 to be updated for each such sub-directory).

Once no further sub-directories are identified in the current directory, the current directory is closed (at 614). After closing the current directory, the value of the variable LEVEL is decremented (at 616) by one, since the traverse procedure 600 is exiting from a directory.

If the determination (at 602) identifies the file system object as not being a directory, then the traverse procedure 600 records (at 618) a respective leaf name string and the corresponding relative level indication (LEVEL) in the backup list 608 and relative level indication file 610, respectively. The traverse procedure 600 then resets (at 620) the value of LEVEL to zero.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
storing, by a system having a processor, leaf names identifying file system objects in a first data structure useable to perform an operation on the identified file system objects, without storing, in the first data structure, information relating to file system paths of the respective file system objects; and
storing, by the system, indications of relative levels of the file system data objects, wherein a given one of the indications specifies a level of the corresponding file system object relative to a previous file system object identified in the first data structure.

2. The method of claim 1, wherein the indications of relative levels are stored in a second data structure separate from the first data structure.

3. The method of claim 2, wherein storing the leaf names in the first data structure comprises storing a list of character strings representing the leaf names.

4. The method of claim 1, wherein the indications of relative levels include numbers, and wherein a particular one of the numbers represents a number of levels of a file system directory tree between a first file system object and a second file system object.

5. The method of claim 4, wherein the particular number is associated with a particular one of the leaf names, and the particular number represents the number of levels of the file system directory tree between the first file system object represented by the particular leaf name and the second file system object represented by a previous leaf name in the first data structure.

6. The method of claim 1, wherein storing the leaf names and storing the indications of relative levels are performed by a reader module of an application based on a namespace of a file system.

7. The method of claim 6, further comprising:
using, by the application, the leaf names and the indications of relative levels to reconstruct the file system paths for the file system objects.

8. The method of claim 7, wherein the application is a backup application, and the method further comprising writing, by a writer module of the backup application to a backup store, data of the file system objects retrieved from the reconstructed file system paths.

9. A system comprising:
at least one processor;
a file system; and
an application executable on the at least one processor to:
access a namespace of the file system to retrieve metadata of file system objects;
generate a first data structure containing leaf names without respective paths of the file system objects; and
generate relative level indications to identify relative levels of the file system objects represented by the leaf names in a hierarchical structure of the namespace, wherein a given one of the relative level indications specifies a level of the corresponding file system object relative to a previous file system object identified in the first data structure.

10. The system of claim 9, wherein the application is to generate the first data structure at a particular point in time, the first data structure including the leaf names of the file system objects existing before the particular point in time, and not including information relating to file system objects created after the particular point in time.

11. The system of claim 9, wherein the application is executable to:
reconstruct file system locations of the file system objects based on the first data structure and the relative level indications.

12. The system of claim 11, wherein the application comprises:
a reader module to perform accessing the namespace, generating the first data structure, and generating the relative level indications, and
a writer module to perform reconstructing the file system locations.

13. The system of claim 12, wherein the writer module is to process the leaf names of the first data structure in sequence, and to use the corresponding relative level indications to determine relative levels of file system objects identified by the leaf names to respective file system objects identified by previous leaf names in the first data structure.

14. The system of claim 9, further comprising a memory to store at least a portion of the first data structure and the relative level indications.

15. An article comprising at least one machine-readable storage medium storing instructions that upon execution cause a system to:
receive a first data structure and relative level indications, the first data structure containing leaf names of file system objects, the first data structure not including paths of the file system objects; and
reconstruct locations of the file system objects in a file system based on the first data structure and the relative level indications, wherein a given one of the relative level indications specifies a level of the corresponding file system object relative to a previous file system object identified by the first data structure.

16. The article of claim 15, wherein the relative level indications include numbers, and wherein a particular one of the numbers represents a number of levels of a file system directory tree between a first file system object and a second file system object.

17. The article of claim 16, wherein the particular number if positive specifies that the first file system object is at a lower hierarchical level in the file system than the second file system object.

18. The article of claim 17, wherein the particular number if negative specifies that the first file system object is at a higher hierarchical level in the file system than the second file system object.

19. The article of claim 18, wherein the particular number if zero specifies that the first file system object is at a same hierarchical level in the file system than the second file system object.

20. The article of claim 15, wherein the instructions upon execution cause the system to further:
write the file system objects retrieved from the reconstructed locations to a backup store, as part of a data backup operation.
